(19) United States
(12) Patent Application Publication
(10) Pub. No.: US 2026/0347725 A1
(43) Pub. Date: Nov. 5, 2026

(54) METHOD FOR EXTRACTING ANTARCTIC KRILL OIL FROM FROZEN ANTARCTIC KRILL

(71) Applicant: Jiangsu Ocean University, Jiangsu (CN)

(72) Inventors: Song WANG, Jiangsu (CN); Xin SHEN, Jiangsu (CN); Ruliang XIE, Jiangsu (CN); Kang MEI, Jiangsu (CN); Li CHEN, Jiangsu (CN)

(21) Appl. No.: 19/125,388

(22) PCT Filed: Jul. 4, 2024
(86) PCT No.: PCT/CN2024/103587

§ 371 Date: Apr. 29, 2025

(30) Foreign Application Priority Data
Jul. 10, 2023 (CN) 202310838874.3

(51) Int. Cl. C11B 1/10; C11B 1/02; C11B 3/10

(52) U.S. Cl. CPC C11B 1/106; C11B 1/02; C11B 3/10

(57) ABSTRACT

A method for extracting Antarctic krill oil from frozen Antarctic krill, comprising the following steps: crushing frozen Antarctic krill, ultrasonically and uniformly mixing with ethanol, and after soaking, carrying out solid-liquid separation to obtain a solid and a supernatant A; mixing the solid with an organic solvent, and repeatedly extracting to obtain Antarctic krill oil 1 having the phospholipid content of 35-40%; and after concentrating the supernatant A, mixing same with an adsorbent, and using ethanol to perform elution extraction to obtain Antarctic krill oil 2 having the phospholipid content of 82% or above, wherein the extraction rate of the two kinds of Antarctic krill oil is 5.2% or above.

### CROSS-REFERENCE TO RELATED APPLICATIONS

This application is a National Stage Application of PCT application No. PCT/CN2024/103587, filed on Jul. 4, 2024, which claims the priority and benefit of Chinese patent application No. 202310838874.3, filed on Jul. 10, 2023. The entireties of PCT application No. PCT/C N2024/103587, Chinese patent application No. 202310838874.3 are hereby incorporated by reference herein and made a part of this specification.

### TECHNICAL FIELD

The disclosure relates to the technical field of food and chemical industry, in particular to a method for extracting Antarctic krill oil from frozen Antarctic krill.

### BACKGROUND ART

Antarctic krill is a type of krill that lives in the waters of Antarctica. It has a high protein content and a low fat content, and has good absorption properties. Antarctic krill also contains rich carotenoids and other substances. In particular, astaxanthin has strong anti-oxidation activity and is the natural pigment with the strongest anti-oxidation and free radical elimination ability in nature. Astaxanthin also has the effect of preventing diabetes and kidney disease, and enhancing immunity. Antarctic krill also contains krill oil, which can reduce the content of total cholesterol and triglycerides in serum, and has multiple functions such as lowering blood lipids, anti-aging, and anti-oxidation. It has high medical value in lowering blood lipids, preventing coronary heart disease, atherosclerosis and other diseases.

In order to improve the edible and medicinal value of Antarctic krill, a growing number of research is being conducted on extracting active ingredients from Antarctic krill. CN104479850A discloses a method for extracting krill oil with high phospholipid content from fresh Antarctic krill. The frozen Antarctic krill is thawed by microwave heating. After thawing, the Antarctic krill is heated and cooked at 80-100 °C, and then the cooked Antarctic krill is separated into solid and liquid by pressing. After centrifuging and pulping an ethanol solution is used to stir and extract with nitrogen at 40-50 °C, the extract is separated. The oil-water phase is subjected to liquid-liquid extraction using a low-polarity solvent. The solid ethanol extract and the oil-water phase liquid-liquid extract are evaporated under reduced pressure respectively, and the organic solvent in the extract or in the liquid-liquid extract is evaporated, and condensed and recovered the extract or the liquid-liquid extract to obtain the Antarctic krill oil. The phospholipid content in Antarctic krill oil is 38-42%, and the Antarctic krill oil also contains astaxanthin, polyunsaturated fatty acids, vitamins and other elements.

CN102041166A discloses a method for extracting Antarctic krill oil with a high phospholipid content from Antarctic krill. The Antarctic krill is first dried at 55-75 °C to prepare dried krill with a water content of 8-10%. The oil in the dried krill is then repeatedly extracted with a non-polar organic solvent at 25-55 °C. However, since the molecular structures of DHA (docosahexaenoic acid), EPA (eicosapentaenoic acid) and astaxanthin in Antarctic krill lipids contain a plurality of double bonds, the phospholipids in Antarctic krill lipids are easily decomposed at high temperatures (80 °C). Therefore, high-temperature cooking treatment will cause the loss of active ingredients, thereby affecting the extraction effect and value.

However, the extraction method with low-temperature mixed solvent will result in a low astaxanthin extraction rate. CN106479662A describes that the krill oil is separated and purified by silica gel column chromatography. Organic solvents such as ethyl acetate and petroleum ether are used, which are highly toxic. In addition, the elution steps of this method are complicated and the elution efficiency is low. Moreover, the particle size of silica gel, the aspect ratio of the elution column, the choice of eluent, the elution method, etc. will affect the separation effect of column chromatography, and thus affect the extraction purity of the active ingredients.

### SUMMARY

The present disclosure aims at the problems in the existing technology, and provides a method for extracting Antarctic krill oil from frozen Antarctic krill. The method directly crushes frozen Antarctic krill instead of heating treatment, and then soaks it in anhydrous ethanol to separate the solid and the supernatant. The solid is repeatedly extracted with an organic solvent to obtain the krill oil. After the supernatant is adsorbed by N-propylethylenediamine and silica gel, the purity of the obtained phospholipids is more than 80%, the overall yield of the krill oil is as high as more than 5.2%, and the content of DHA and EPA is increased.

In order to achieve the above-mentioned purpose of the disclosure,

In one aspect, the present disclosure provides a method for extracting Antarctic krill oil from frozen Antarctic krill, including the following steps:
(1) crushing frozen Antarctic krill to obtain frozen Antarctic krill powder;
(2) applying an ultrasonic treatment for mixing the frozen Antarctic krill powder and ethanol, then soaking, and then solid-liquid separating to obtain a solid and a supernatant A;
(3) mixing the solid with an organic solvent, extracting, solid-liquid separating, and collecting a liquid B1 and a solid B1, repeating this process 1-3 times, combining the liquids, and obtaining a mixed liquid B;
(4) concentrating the mixed liquid B to obtain Antarctic krill oil 1;
(5) concentrating the supernatant A of the step (2) to obtain a concentrated solution, mixing the concentrated solution with an adsorbent, and stirring to obtain a mixture;
(6) solid-liquid separating the mixture of the step (5) to obtain an adsorbent enriched with the concentrated solution;
(7) mixing the adsorbent enriched with the concentrated solution of the step (6) with ethanol, extracting, solid-liquid separating, collecting a supernatant, and concentrating to obtain Antarctic krill oil 2.

Preferably, in the step (1), the particle size of the Antarctic krill powder is 80-200 mesh.

In the present disclosure, the frozen Antarctic krill does not need to be thawed.

Preferably, in the step (2), the mass volume ratio of the frozen Antarctic krill powder to the ethanol is 1:0.6-2.0 kg/L.

Further preferably, the mass volume ratio of the frozen Antarctic krill powder to the ethanol is 1:0.8-1.5 kg/L.

Preferably, in the step (2), the ethanol is anhydrous ethanol.

Preferably, in the step (2), the soaking is carried out at room temperature for 10-40 min.

Preferably, in the step (3), the organic solvent is selected from at least one of anhydrous ethanol and ethyl acetate.

Preferably, in the step (3), the mass volume ratio of the solid to the organic solvent is 1:4-10 kg/L.

Further preferably, the mass volume ratio of the solid to the organic solvent is 1:4-8 kg/L.

Preferably, in the step (3), the extraction temperature of the extracting is 35-45 °C, the extraction time is 1-4 h, and the extracting is shaking extracting.

Further preferably, the extraction temperature is 40 °C.

Preferably, in the steps (4)-(5), the concentrating is carried out under reduced pressure, and the concentration temperature is 38-45 °C.

Preferably, in the step (5), the concentration is carried out to concentrate to 40-70% of the original volume.

Preferably, in the step (5), the adsorbent is a mixture of C18 (octadecylsilyl bonded silica gel) and PSA (N-propylethylenediamine), and the mass ratio of the C18 to the PSA is 1:0.6-2.0.

Further preferably, the mass ratio of the C18 to the PSA is 1:0.8-1.5.

More preferably, the particle size of the C18 is 4-8 μm, and the particle size of the PSA is 40-60 μm.

Preferably, in the step (5), the mass volume ratio of the adsorbent to the concentrated solution is 1:3-8 kg/L.

Further preferably, the mass volume ratio of the adsorbent to the concentrated solution is 1:4-6 kg/L.

Preferably, in the step (5), the stirring is carried out at room temperature for 15-50 min, until the adsorbent fully absorbs the phospholipids in the concentrated solution.

Preferably, in the step (7), the mass volume ratio of the adsorbent enriched with the concentrated solution to the ethanol is 1:3-8 kg/L.

Further preferably, the mass volume ratio of the adsorbent enriched with the concentrated solution to the ethanol is 1:4-6 kg/L.

Preferably, in the step (7), the extraction temperature of the extracting is 35-45 °C, the extraction time is 20-90 min, and the extracting is shaking extracting.

Further preferably, the extraction temperature is 38-42 °C and the extraction time is 25-60 min.

In the present disclosure, the method for solid-liquid separating is a conventional separation method in the art, preferably a high-speed centrifugation method.

In the present disclosure, the concentrating is reduced pressure concentrating, and the concentration temperature is 38-45 °C.

In another aspect, the present disclosure provides Antarctic krill oil obtained by the above method.

In the present disclosure, two types of the Antarctic krill oil are obtained, namely Antarctic krill oil 1 and Antarctic krill oil 2. The phospholipid content of one Antarctic krill oil (Antarctic krill oil 1) is above 35%, the phospholipid content of the other Antarctic krill oil (Antarctic krill oil 2) is above 82%, the DHA content is above 12.8%, and the EPA content is above 21.8%. The sum of the yields of the two types of Antarctic krill oil is above 5.2%.

Compared with the existing technology, the beneficial effects of the disclosure are that:
1. According to the method for extracting Antarctic krill oil of the present disclosure, the frozen Antarctic krill is directly extracted without thawing or heating treatment. The effective active ingredients such as phospholipids in the Antarctic krill oil can be kept from losing. The deterioration of polyunsaturated fatty acids DHA, EPA and astaxanthin are reduced. The byproduct lysophospholipid content in the obtained krill oil is less than 5 ppm. The quality and purity of the extract is improved.
2. The method for extracting Antarctic krill oil of the present disclosure overcomes the problem of difficulty in extracting effective ingredients from frozen Antarctic krill. The Antarctic krill oil 1 with a phospholipid content of 35-40% is obtained using ultrasound, ethanol and/or ethyl acetate organic solvents for preliminary extraction. After supernatant A is concentrated and adsorbed with an adsorbent, high-purity Antarctic krill oil 2 with a phospholipid content of more than 82% is obtained. The krill oil products with different phospholipid contents are configured according to different product requirements, which not only improves the utilization rate of Antarctic krill, but also improves the utilization value of krill oil. The extraction rates of the two types of Antarctic krill oil are more than 5.2%. The present disclosure significantly improves the extraction rate of the Antarctic krill oil.
3. According to the method for extracting Antarctic krill oil of the present disclosure, the supernatant A is obtained by ultrasonic treatment with ethanol. After adsorption with the adsorbent mixed by C18 and PSA, the content of phospholipids in the recovered Antarctic krill oil is more than 82%. In addition, the Antarctic krill oil is rich in other active ingredients. The contents of DHA, EPA and astaxanthin are also significantly increased. The nutritional value of the Antarctic krill oil is improved.

### DETAILED DESCRIPTION

The following non-limiting examples may enable a person skilled in the art to more fully understand the present disclosure, but are not intended to limit the present disclosure in any way. The following contents are merely exemplary of the scope of protection claimed by the present disclosure. Those skilled in the art may make various changes and modifications to the present disclosure based on the disclosed contents, and such changes and modifications should also fall within the scope of protection claimed by this disclosure.

When numerical ranges are given in the embodiment, it should be understood that both endpoints of each numerical range and any numerical value between the two endpoints can be selected unless otherwise specified in the present disclosure. Unless defined otherwise, all technical and scientific terms used herein have the same meaning as commonly understood by one of ordinary skill in the art to which this disclosure belongs.

The present disclosure is further described in the form of specific examples. Unless otherwise specified, the various chemical reagents used in the examples of the present disclosure were obtained through conventional commercial channels. Reagents from different manufacturers had no significant effect on the results.

In the present disclosure, the phospholipid content detection method refers to the national standard GB/T5537-2008;
the detection method of the DHA content and EPA content is carried out in accordance with the national standard 5009.168-2016 National Food Safety Standard Determination of Fatty Acids in Food, and the GC-MS method is used for detection;
the astaxanthin content detection method is based on the filing information on the official website of the U.S. Food and Drug Administration.

In the present disclosure, the yield of the Antarctic krill oil (%)=the mass of the obtained Antarctic krill oil/the mass of the frozen Antarctic krill×100%.

### Example 1

A method for extracting Antarctic krill oil from frozen Antarctic krill, including following steps:
(1) frozen Antarctic krill was crushed with a particle size sieving of 80 mesh to obtain frozen Antarctic krill powder;
(2) the frozen Antarctic krill powder and ethanol were ultrasonically and uniformly mixed at a mass volume ratio of 1:1(kg/L), soaked at room temperature for 20 min, and centrifuged at high speed to separate the solid and liquid to obtain a solid and a supernatant A;
(3) the solid was mixed with anhydrous ethanol at a mass volume ratio of 1:4 (kg/L), extracted on a shaking incubator at 40 °C for 1 h, and centrifuged at high speed to separate the solid and liquid, and the liquid B1 and solid B1 were collected; this extraction step was repeated twice, and the liquids were combined to obtain a mixed liquid B;
(4) the mixed liquid B was concentrated under reduced pressure at 40 °C to remove the ethanol to obtain Antarctic krill oil 1, the phospholipid content was 35.0%, DHA was 7.2%, EPA was 13.2%, astaxanthin was 390 ppm, and the Antarctic krill oil yield was 3.9% based on wet weight;
(5) the supernatant A of the step (2) was concentrated under reduced pressure at 40 ° C for 20-30 min (to remove part of the ethanol), so that the concentrated volume was 45-55% of the original volume to obtain a concentrated solution, which was mixed with an adsorbent (C18:PSA=1:1, mass ratio), a mass volume ratio of the adsorbent to the concentrated solution was 1:5 (kg/L), the mixture was fully stirred at room temperature for 30 min to allow the adsorbent to fully adsorb the phospholipids in the concentrated solution to obtain a mixture. In this example, the average particle size of the adsorbent C18 was 4-5 μm, and the average particle size of the adsorbent PSA was 40-50 μm;
(6) the mixture of the step (5) was centrifuged at high speed to separate the solid and liquid to obtain an adsorbent enriched with the concentrated solution;
(7) the adsorbent enriched with the concentrated solution of the step (6) was fully mixed with anhydrous ethanol at a mass volume ratio of 1:5 (kg/L), extracted on a shaking incubator at 40 °C for 30 min, centrifuged at high speed to separate the solid and liquid, the supernatant was collected and concentrated under reduced pressure at 40 °C to remove ethanol to obtain Antarctic krill oil 2; the phospholipid content was 82.0%, DHA was 12.8%, EPA was 21.8%, astaxanthin was 520 ppm, the Antarctic krill oil yield was 1.52% based on wet weight; and the byproduct lysophospholipid content was at most 0.20 ppm, which was generally regarded as undetected (ND).

### Example 2

A method for extracting Antarctic krill oil from frozen Antarctic krill, including following steps:
(1) frozen Antarctic krill was crushed with a particle size sieving of 150 mesh to obtain frozen Antarctic krill powder;
(2) the frozen Antarctic krill powder and ethanol were ultrasonically and uniformly mixed at a mass volume ratio of 1:1(kg/L), soaked at room temperature for 20 min, and centrifuged at high speed to separate the solid and liquid to obtain a solid and a supernatant A;
(3) the solid was mixed with anhydrous ethanol at a mass volume ratio of 1:8 (kg/L), extracted on a shaking incubator at 40 °C for 1 h, and centrifuged at high speed to separate the solid and liquid, and the liquid B1 and solid B1 were collected; this extraction step was repeated twice, and the liquids were combined to obtain a mixed liquid B;
(4) the mixed liquid B was concentrated under reduced pressure at 40 °C to remove the ethanol to obtain Antarctic krill oil 1, the phospholipid content was 36.2%, DHA was 7.3%, EPA was 13.3%, astaxanthin was 386 ppm, and the Antarctic krill oil yield was 3.8% based on wet weight;
(5) the supernatant A of the step (2) was concentrated under reduced pressure at 40 °C for 20-30 min (to remove part of the ethanol), so that the concentrated volume was about 50% of the original volume to obtain a concentrated solution, which was mixed with an adsorbent (C18:PSA=1:1, mass ratio), a mass volume ratio of the adsorbent to the concentrated solution was 1:4 (kg/L), the mixture was fully stirred at room temperature for 30 min to allow the adsorbent to fully adsorb the phospholipids in the concentrated solution to obtain a mixture. In this example, the average particle size of the adsorbent C18 was 6-7 μm, and the average particle size of the adsorbent PSA was 50-60 μm;
(6) the mixture of the step (5) was centrifuged at high speed to separate the solid and liquid to obtain an adsorbent enriched with the concentrated solution;
(7) the adsorbent enriched with the concentrated solution of the step (6) was fully mixed with anhydrous ethanol at a mass volume ratio of 1:5 (kg/L), extracted on a shaking incubator at 40 °C for 30 min, centrifuged at high speed to separate the solid and liquid, the supernatant was collected and concentrated under reduced pressure at 40 °C to remove ethanol to obtain Antarctic krill oil 2; the phospholipid content was 83.2%, DHA was 13.1%, EPA was 22.8%, astaxanthin was 510 ppm, the Antarctic krill oil yield was 1.48% based on wet weight; and the byproduct lysophospholipid content was at most 0.25 ppm, which was generally regarded as undetected (ND).

### Example 3

A method for extracting Antarctic krill oil from frozen Antarctic krill, including following steps:
(1) frozen Antarctic krill was crushed with a particle size sieving of 200 mesh to obtain frozen Antarctic krill powder;
(2) the frozen Antarctic krill powder and ethanol were ultrasonically and uniformly mixed at a mass volume ratio of 1:0.8(kg/L), soaked at room temperature for 40 min, and centrifuged at high speed to separate the solid and liquid to obtain a solid and a supernatant A;
(3) the solid was mixed with ethyl acetate at a mass volume ratio of 1:4 (kg/L), extracted on a shaking incubator at 45 °C for 2 h, and centrifuged at high speed to separate the solid and liquid, and the liquid B1 and solid B1 were collected; this extraction step was repeated twice, and the liquids were combined to obtain a mixed liquid B;
(4) the mixed liquid B was concentrated under reduced pressure at 40 °C to remove the ethanol to obtain Antarctic krill oil 1, the phospholipid content was 35.9%, DHA was 7.3%, EPA was 13.4%, astaxanthin was 402 ppm, and the Antarctic krill oil yield was 3.87% based on wet weight;
(5) the supernatant A of the step (2) was concentrated under reduced pressure at 40 °C (to remove part of the ethanol), so that the concentrated volume was 45-55% of the original volume to obtain a concentrated solution, which was mixed with an adsorbent (C18:PSA=1:1.5, mass ratio), a mass volume ratio of the adsorbent to the concentrated solution was 1:5 (kg/L), the mixture was fully stirred at room temperature for 30 min to allow the adsorbent to fully adsorb the phospholipids in the concentrated solution to obtain a mixture. In this example, the average particle size of the adsorbent C18 was 4-5 μm, and the average particle size of the adsorbent PSA was 40-50 μm;
(6) the mixture of the step (5) was centrifuged at high speed to separate the solid and liquid to obtain an adsorbent enriched with the concentrated solution;
(7) the adsorbent enriched with the concentrated solution of the step (6) was fully mixed with anhydrous ethanol at a mass volume ratio of 1:5 (kg/L), extracted on a shaking incubator at 45 °C for 60 min, centrifuged at high speed to separate the solid and liquid, the supernatant was collected and concentrated under reduced pressure at 40 °C to remove ethanol to obtain Antarctic krill oil 2; the phospholipid content was 83.6%, DHA was 13.4%, EPA was 21.6%, astaxanthin was 493 ppm, the Antarctic krill oil yield was 1.66% based on wet weight; and the byproduct lysophospholipid content was 0.46 ppm, which was generally regarded as undetected (ND).

### Example 4

A method for extracting Antarctic krill oil from frozen Antarctic krill, including following steps:
(1) frozen Antarctic krill was crushed with a particle size sieving of 100 mesh to obtain frozen Antarctic krill powder;
(2) the frozen Antarctic krill powder and ethanol were ultrasonically and uniformly mixed at a mass volume ratio of 1:1.5 (kg/L), soaked at room temperature for 10 min, and centrifuged at high speed to separate the solid and liquid to obtain a solid and a supernatant A;
(3) the solid was mixed with anhydrous ethanol at a mass volume ratio of 1:10 (kg/L), extracted on a shaking incubator at 35 °C for 4 h, and centrifuged at high speed to separate the solid and liquid, and the liquid B1 and solid B1 were collected; this extraction step was repeated twice, and the liquids were combined to obtain a mixed liquid B;
(4) the mixed liquid B was concentrated under reduced pressure at 40 °C to remove the ethanol to obtain Antarctic krill oil 1, the phospholipid content was 37.7%, DHA was 7.6%, EPA was 14.1%, astaxanthin was 512 ppm, and the Antarctic krill oil yield was 3.94% based on wet weight;
(5) the supernatant A of the step (2) was concentrated under reduced pressure at 40 °C (to remove part of the ethanol), so that the concentrated volume was about 50% of the original volume to obtain a concentrated solution, which was mixed with an adsorbent (C18:PSA=1:0.8, mass ratio), a mass volume ratio of the adsorbent to the concentrated solution was 1:6 (kg/L), the mixture was fully stirred at room temperature for 50 min to allow the adsorbent to fully adsorb the phospholipids in the concentrated solution to obtain a mixture. In this example, the average particle size of the adsorbent C18 was 7-8 μm, and the average particle size of the adsorbent PSA was 40-50 μm;
(6) the mixture of the step (5) was centrifuged at high speed to separate the solid and liquid to obtain an adsorbent enriched with the concentrated solution;
(7) the adsorbent enriched with the concentrated solution of the step (6) was fully mixed with anhydrous ethanol at a mass volume ratio of 1:8 (kg/L), extracted on a shaking incubator at 35 °C for 90 min, centrifuged at high speed to separate the solid and liquid, the supernatant was collected and concentrated under reduced pressure at 40 °C to remove ethanol to obtain Antarctic krill oil 2; the phospholipid content was 83.5%, DHA was 12.9%, EPA was 22.4%, astaxanthin was 523 ppm, the Antarctic krill oil yield was 1.59% based on wet weight; and the byproduct lysophospholipid content was 0.28 ppm, which was generally regarded as undetected (ND).

### Comparative Example 1

The difference from Example 1 is that the adsorbent is different:
the adsorbent (the mixture of C18 and PSA) of the step (5) was replaced with a cation exchange resin containing a sulfonic acid group (HND-8 cation exchange resin).

At last, the obtained Antarctic krill oil 2 had a phospholipid content of 46.5%, DHA 6.7%, EPA 12.4%, and astaxanthin 368 ppm. The Antarctic krill oil yield was 2.81% based on wet weight, and the byproduct lysophospholipid content was 55.8 ppm.

### Comparative Example 2

The krill oil was prepared by the method described in Example 1 of CN104479850A, specifically:
(1) Thawing: 500 g of frozen Antarctic krill were taken to heat and thaw by microwave for 5 minutes;
(2) Heating and cooking: the thawed Antarctic krill was heated and cooked at 100 °C for 10 minutes;
(3) Dehydration: physical pressing was used to separate the solid and liquid of the cooked Antarctic krill;
(4) Centrifugation: the squeezed liquid was centrifuged for secondary solid-liquid separation to obtain an oil-water phase and a solid;
(5) Homogenization: the solids obtained in (3) and (4) were combined and pulped with a homogenizer;
(6) Extraction: the solids were stirred and extracted with a 95% or higher ethanol solution at 40-50 °C in a fully enclosed electric stirring and extraction tank. The mass volume ratio was of the solid and liquid was 1:10, and the time was 1 hour. Nitrogen was introduced into the extraction tank during the extraction process. The extract was separated, and the separated extract was extracted again and separated twice. The solid-liquid ratio of the krill to be extracted each time to the 95% or higher ethanol solution was 1:10, the extraction time was 2 hours each time, the extracts were combined;
(7) Liquid-liquid extraction: the oil-water phase was subjected to liquid-liquid extraction using n-hexane. The solvent/liquid volume ratio was 2:1. The extraction temperature was 25 °C, the extraction was performed twice, and the extracts were combined;
(8) Desolventization: the solid ethanol extract was evaporated under reduced pressure at a temperature of 40 °C and a vacuum degree of −0.1 MPa. The oil-water phase extract was evaporated under reduced pressure at 25 °C and a vacuum degree of −0.1 MPa, and the organic solvent in the extract or in the liquid-liquid extract was evaporated, and condensed to recover two types of crude Antarctic krill oil. Nitrogen was further introduced into the two types of crude Antarctic krill oil to remove the residual organic solvent in the krill oil, and the Antarctic krill oil was obtained after combining. The total extraction rate of the krill oil was 3.3%, the byproduct lysophospholipid content was about 50 ppm, the phospholipid content was 40.2%, the DHA content was 6.2%, the EPA content was 11.9%, and the astaxanthin content was 390 ppm.

The method for extracting Antarctic krill oil of the present disclosure does not use cooking and pressing for dehydration, but directly uses ethanol for dehydration at low temperature. The damage of high temperature to phospholipids is reduced. The byproduct lysophospholipids in the obtained krill oil is only 0.2-0.5 ppm, which is generally undetectable and significantly lower than 50 ppm in the comparative example.

The present disclosure adopts a mixture of C18:PSA=1:1 (mass ratio) as an adsorbent to recover phospholipids in the organic solvent, which can maximize the phospholipid content and extraction rate, and the phospholipid content can reach more than 82%. Compared with the existing technology that uses polar solvents to directly extract and squeeze the phospholipids in the dehydrated phase, which is impossible to effectively separate and obtain the phospholipids in the water phase, the method of the present disclosure greatly increases the phospholipid content.

The method of the present disclosure can obtain two types of Antarctic krill oil with phospholipid contents of 35-40% and 82% or more, respectively. Antarctic krill oil products with different concentrations can be configured according to different product requirements. While the comparative example 2 can only obtain Antarctic krill oil with a fixed phospholipid content of 38-42% at once.

The dehydration method of the present disclosure reduces the deterioration of polyunsaturated fatty acids DHA, EPA and astaxanthin, since it does not undergo a high-temperature process, so that the quality of Antarctic krill oil and the content of various nutrients are better than those of the comparative example.

### Comparative Example 3

The difference from Example 1 was that, in the step (3), the organic solvent anhydrous ethanol was replaced by a mixture of methanol and ethyl acetate in a volume ratio of 0.8:1.8 (v/v).

The Antarctic krill oil 1 was obtained, which had a phospholipid content of 22.5%, DHA of 4.2%, EPA of 6.9%, astaxanthin of 367 ppm, and the Antarctic krill oil yield of 2.16% based on wet weight.

The Antarctic krill oil 2 was the same as that in Example 1.

### Comparative Example 4

The difference from Example 1 was that in the step (5), the adsorbent was replaced by silica gel with a particle size between 200-300 mesh. That is, the particle sizes of silica gel were different.

The obtained Antarctic krill oil 2 had a phospholipid content of 53.2%, DHA of 9.8%, EPA of 17.1%, astaxanthin of 420 ppm, and the Antarctic krill oil yield of 1.09% based on wet weight.

### Comparative Example 5

The difference from Example 1 was that in the step (7), the anhydrous ethanol (eluent) was replaced by methanol, specifically: the adsorbent enriched with the concentrated solution of the step (6) was fully mixed with methanol at a mass volume ratio of 1:5 (kg/L), extracted on a shaking incubator at 40 °C for 30 min, centrifuged at high speed to separate the solid and liquid, and the supernatant was collected. After the methanol was removed by concentrating under reduced pressure at 40 °C, the Antarctic krill oil 2 was obtained, the phospholipid content was 58.2%, DHA was 9.3%, EPA was 19.8%, astaxanthin was 414 ppm, and the Antarctic krill oil yield was 0.96% based on wet weight.

### Comparative Example 6

The difference from Example 1 was that in the step (7), the extraction temperature was 62 °C, specifically: the adsorbent enriched with the concentrated solution of the step (6) was fully mixed with anhydrous ethanol at a mass volume ratio of 1:5 (kg/L), extracted on a shaking incubator at 62 °C for 30 min, centrifuged at high speed to separate the solid and liquid, and the supernatant was collected. After the ethanol was removed by concentrating under reduced pressure at 40 °C, the Antarctic krill oil 2 was obtained, the phospholipid content was 54.7%, DHA was 10.6%, EPA was 19.0%, astaxanthin was 393 ppm, and the Antarctic krill oil yield was 1.03% based on wet weight, the byproduct lysophospholipid content was 42 ppm.

The above is a further description of the present disclosure in combination with specific embodiments, but these embodiments are merely exemplary and do not constitute any limitation to the scope of the present disclosure. Those skilled in the art should understand that the details and forms of the technical solutions of the present disclosure may be modified or replaced without departing from the spirit and scope of the present disclosure, but these modifications and replacements are within the protection scope of the present disclosure.

1. A method for extracting Antarctic krill oil from frozen Antarctic krill, comprising following steps:
(1) crushing the frozen Antarctic krill to obtain frozen Antarctic krill powder;
(2) applying an ultrasonic treatment for mixing the frozen Antarctic krill powder and ethanol, then soaking, and then solid-liquid separating to obtain a solid and a first supernatant;
(3) mixing the solid with an organic solvent, extracting, solid-liquid separating, and collecting a liquid and a second solid, repeating this process 1-3 times, combining the liquids, and obtaining a mixed liquid;
(4) concentrating the mixed liquid to obtain first Antarctic krill oil;
(5) concentrating the first supernatant of the step (2) to obtain a concentrated solution, mixing the concentrated solution with a first adsorbent, and stirring to obtain a mixture;
(6) solid-liquid separating the mixture of the step (5) to obtain a second adsorbent enriched with the concentrated solution; and
(7) mixing the second adsorbent enriched with the concentrated solution of the step (6) with ethanol, extracting, solid-liquid separating, collecting a second supernatant, and concentrating to obtain second Antarctic krill oil.

2. The method according to claim 1, wherein in the step (2), a mass volume ratio of the frozen Antarctic krill powder to the ethanol is 1:0.6-2.0 kg/L, the ethanol is anhydrous ethanol, the soaking is room temperature soaking, and a soaking time is 10-40 min.

3. The method according to claim 1, wherein in the step (3), the organic solvent is selected from at least one of anhydrous ethanol or and ethyl acetate, and a mass volume ratio of the solid to the organic solvent is 1:4-10 kg/L.

4. The method according to claim 1, wherein in the step (3), an extraction temperature of the extracting is 35-45 °C, an extraction time is 1-4 h, and the extracting is shaking extracting.

5. The method according to claim 1, wherein in the steps (4)-(5), the concentrating is reduced pressure concentrating, and a concentration temperature is 38-45 °C.

6. The method according to claim 1, wherein in the step (5), the first adsorbent is a mixture of octadecylsilyl bonded silica gel and N-propylethylenediamine, a mass ratio of the octadecylsilyl bonded silica gel to the N-propylethylenediamine is 1:0.6-2.0, a particle size of the octadecylsilyl bonded silica gel is 4-8 μm, and a particle size of the N-propylethylenediamine is 40-60 μm.

7. The method according to claim 6, wherein the mass ratio of the octadecylsilyl bonded silica gel to the N-propylethylenediamine is 1:0.8-1.5.

8. The method according to claim 1, wherein in the step (5), a mass volume ratio of the first adsorbent to the concentrated solution is 1:3-8 kg/L, and the stirring is a stirring at room temperature for 15-50 min.

9. The method according to claim 1, wherein in the step (7), a mass volume ratio of the second adsorbent enriched with the concentrated solution to the ethanol is 1:3-8 kg/L, an extraction temperature of the extracting is 35-45 °C, an extraction time is 20-90 min, and the extracting is shaking extracting.

10. Antarctic krill oil prepared by the method according to claim 1.
